(19) United States
(12) Patent Application Publication
(10) Pub. No.: US 2020/0184098 A1
(43) Pub. Date: Jun. 11, 2020

(54) Systems and Methods for Secure Obfuscation of Sensitive Information in Images

(71) Applicant: HELIX RE, Inc., San Mateo, CA (US)

(72) Inventors: Christopher Jordan Andrasick, Half Moon Bay, CA (US); Nicolas Chaulet, London (GB)

(21) Appl. No.: 16/212,180

(22) Filed: Dec. 6, 2018

(51) Int. Cl. G06F 21/62; G06T 5/00; G06T 7/90; G06T 11/00; G06F 21/60

(52) U.S. Cl. CPC G06F 21/6245; G06T 5/002; G06T 7/90; G06T 5/40; G06T 11/001; G06F 21/602; G06T 5/005

(57) ABSTRACT

Provided herein are exemplary methods for image obfuscation with a computing device, including partitioning an image into pixel clusters, encrypting the pixel clusters, and using a blur technique to blend pixilation. Exemplary methods herein may also include the partitioning being based upon colors in the image, using a vector quantization function that groups pixels based on red, green, or blue color values according to a nearest mean, and/or generating output in a form of Voroni cells, with each Voroni cell representing a cluster of pixels with similar colors. Exemplary systems for image obfuscation may include a processor, and a memory for storing executable instructions, the processor executing the instructions to partition an image into pixel clusters, encrypt the pixel clusters and use a blur technique to blend pixilation.

### FIELD OF THE TECHNOLOGY

The present technology relates generally to image obfuscation with computing devices or other devices.

### SUMMARY OF THE PRESENT TECHNOLOGY

Exemplary methods herein for image obfuscation with a computing device include partitioning an image into pixel clusters, encrypting the pixel clusters, and using a blur technique to blend pixilation. Exemplary methods herein may also include the partitioning being based upon colors in the image, using a vector quantization function that groups pixels based on red, green, or blue color values according to a nearest mean, and/or generating output in a form of Voroni cells, with each Voroni cell representing a cluster of pixels with similar colors.

A largest cluster, in exemplary embodiments, may represent background pixels of the image being analyzed. Further, the background pixels may represent a whiteboard or computer screen, including foreground pixels with handwriting, diagrams, displayed text or imagery. Methods may include inpainting or interpolating the foreground pixels with the background pixels and using the background pixels to interpolate pixel color values for each pixel in the foreground, resulting in the foreground pixels fading into the background pixels.

According to various exemplary methods, encrypting the pixel clusters by shuffling each pixel cluster with a set of neighboring pixel clusters may occur, and may further include shuffling multiple times with a different set of neighboring pixel clusters. Additionally, permanently and randomly changing a numerical color value of each pixel based on available neighboring pixel clusters may also occur, along with adding random noise that appears aesthetically consistent with a scene to a human eye, but cannot computationally be reversed. In further exemplary methods, a grainy version of the output of the step of partitioning the image into pixel clusters may be generated. A traditional blur technique such as Gaussian or bilateral, in many exemplary embodiments, may be used to blend the pixilation caused by the injected noise.

Exemplary systems for image obfuscation may include a processor, and a memory for storing executable instructions, the processor executing the instructions to partition an image into pixel clusters, encrypt the pixel clusters and use a blur technique to blend pixilation. Exemplary systems may also include the partitioning being based upon colors in the image, using a vector quantization function that groups pixels based on red, green, or blue color values according to a nearest mean, and generating output in a form of Voroni cells.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 shows an exemplary image of a whiteboard with sensitive content.

FIG. 2 shows an exemplary color histogram produced by partitioning an image into pixel clusters.

FIG. 3 shows the exemplary image of a whiteboard with the sensitive content of FIG. 1, after the partitioning the image into pixel clusters, the image color partitioning and foreground in painting applied.

FIG. 4 shows an exemplary result of FIG. 1, after the foreground in the painting and introduction of stochastic noise sourced from neighboring pixel colors is applied.

FIG. 5 shows an exemplary result of FIG. 1 after partitioning the image into pixel clusters, encrypting the pixel clusters, and using a blur technique to blend pixilation.

FIG. 6 is an exemplary diagram showing an exemplary sequence of the steps described herein.

FIG. 7 is a diagrammatic representation of an exemplary system.

FIG. 8 shows an exemplary real-life scenario of a whiteboard with information on it prior to performing the systems and methods described and illustrated herein.

FIG. 9 shows an exemplary real-life scenario of the whiteboard of FIG. 8 with a marquee boundary around the information to be obfuscated on the whiteboard.

FIG. 10 shows an exemplary real-life scenario of the whiteboard of FIGS. 8-9 with the information on the whiteboard obfuscated.

### DETAILED DESCRIPTION

There is a need for improvement in the processing of digital images that contain sensitive information such as that found on corporate whiteboards, displayed on computer screens and posted in sensitive areas.

The exemplary embodiments herein provide for the secure, irreversible obfuscation of sensitive information in one or more defined areas of an image. This is accomplished through a three-step method that begins with partitioning the colors of the affected area into clusters such that the background and foreground become separable. The foreground representing the sensitive content to be obfuscated is then inpainted with the surrounding background. In the second step, the resulting pixels are then randomly shuffled with their neighbors a varying number of times. The final step applies a standard blur such as a Gaussian, median or bilateral technique to blend the resulting pixels.

Described and illustrated herein are obfuscation techniques that identify and remove elements that contrast with a background, apply a randomizing step akin to permanent encryption of the chosen area, blur the output of the foregoing, and require no specialized hardware.

The first step (hereafter “Step 1”) partitions the image area being obfuscated into pixel clusters based on the colors in the area. This is accomplished using a vector quantization function that groups pixels based on the red, green, blue color values according to the nearest mean. The resulting output is a set of Voronoi cells with each cell representing a cluster of pixels with similar color. The largest cluster is assumed to represent the background of the area being analyzed. This background may represent a whiteboard or computer screen with the foreground in this context being handwriting, diagrams, displayed text or imagery.

The foreground pixels are then inpainted with the background pixels. This technique is also commonly known as image interpolation. The background pixels are used to interpolate pixel color values for each pixel in the foreground. The result is that the foreground pixels ‘fade’ into the background.

The second step (hereafter “Step 2”) encrypts these pixels by shuffling each with a set of neighboring pixels. Each pixel in the image area is shuffled multiple times, each time with a different set of neighbors. The approach permanently and randomly changes the numerical color values of each pixel based on the available neighbors. The step adds random noise that appears aesthetically consistent with the scene to the human eye, but is computationally extremely difficult if not impossible to reverse.

The output of the Step 2 is a grainy version of the output of Step 1 as it has been injected with random noise generated from neighboring pixels.

The final, third step (hereafter “Step 3”) in the method uses a traditional blur technique such as Gaussian or bilateral with the intended result being to blend the pixelation caused by the injected noise from Step 2. The third blurring step can use these known and reversible techniques as they are being applied to an already secured image. The step is applied for purely aesthetic purposes.

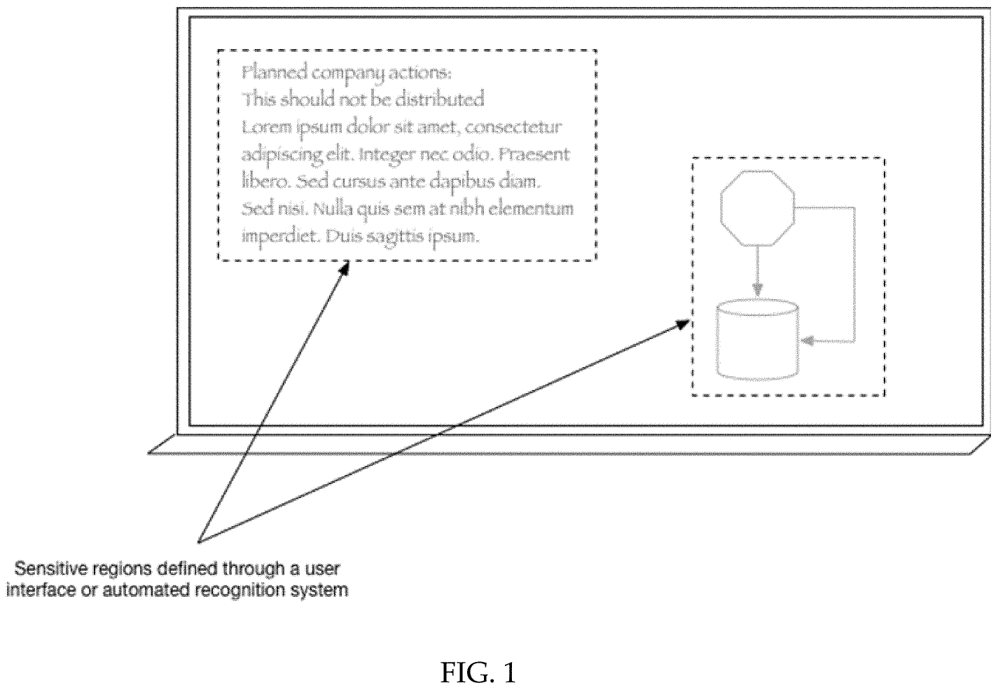

FIG. 1 shows an exemplary image of a whiteboard with sensitive content.

For example, FIG. 1 may represent an illustrative example of sensitive information posted to a whiteboard in a place of business. A rectangular marquee has been drawn to define the boundary around the sensitive area of the image to be obfuscated. This marquee may be represented as any polygonal or circular shape or pixel mask. The pixels within the boundary may be selected by a pre-defined border or shape, a person using a computer software program to draw the boundary or an object detection algorithm. One or more sensitive regions may be defined in a single image.

Each area or region of pixels to be obfuscated will be subject to three steps. In Step 1, clusters of pixels with similar colors will be created. These colors may be defined in grayscale or any available color format that digitally represents color as one or more numerical values. These formats include RGB (red, green, blue), HSV (hue, saturation, value), LAB (lightness and the green-red and blue-yellow color components) or any defined color space represented by numerical values.

The colors may be clustered with any machine learning algorithm used to group data points along multiple color dimensions. Examples of clustering methods include K-Means, Mean-Shift, Density-Based Spatial, Expectation-Maximization, Agglomerative Hierarchical and similar techniques that group data points with many numerical dimensions.

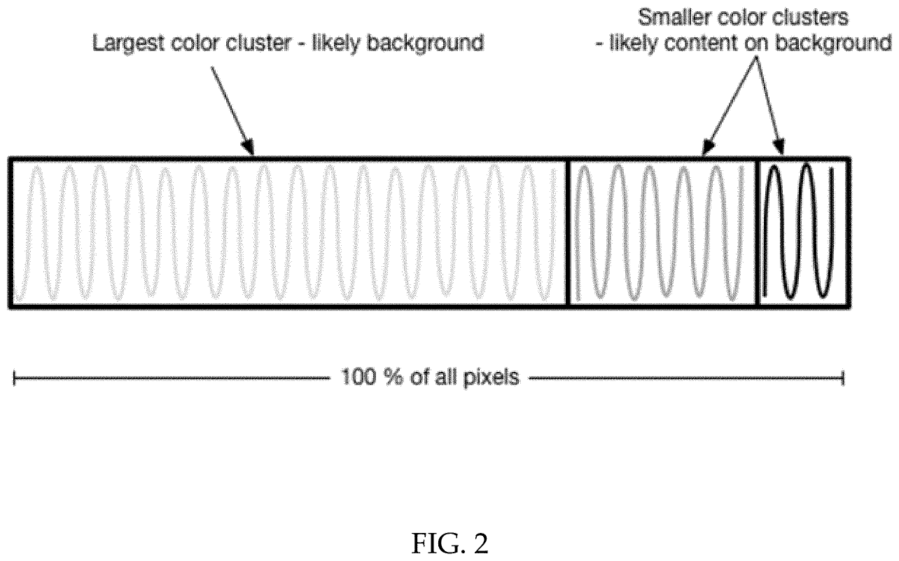

FIG. 2 shows an exemplary color histogram produced by partitioning an image into pixel clusters.

The clusters are then sorted by the quantity of pixels in each, together comprising a color histogram as shown in FIG. 2. The cluster with the highest number of pixels is presumed to represent background elements that comprise the medium upon which sensitive content such as writing, diagrams or imagery resides. The sensitive content will deliberately contrast with this background so as to be visible. Examples of background include but are not limited to portions of a whiteboard with no text or diagrams, portions of a computer display with no text or diagrams, and the background color of a sign or poster. Once these clusters are defined, the distance between the presumed background cluster and each pixel in the region being analyzed is calculated. Pixels that are close to the largest cluster are defined as background pixels and preserved.

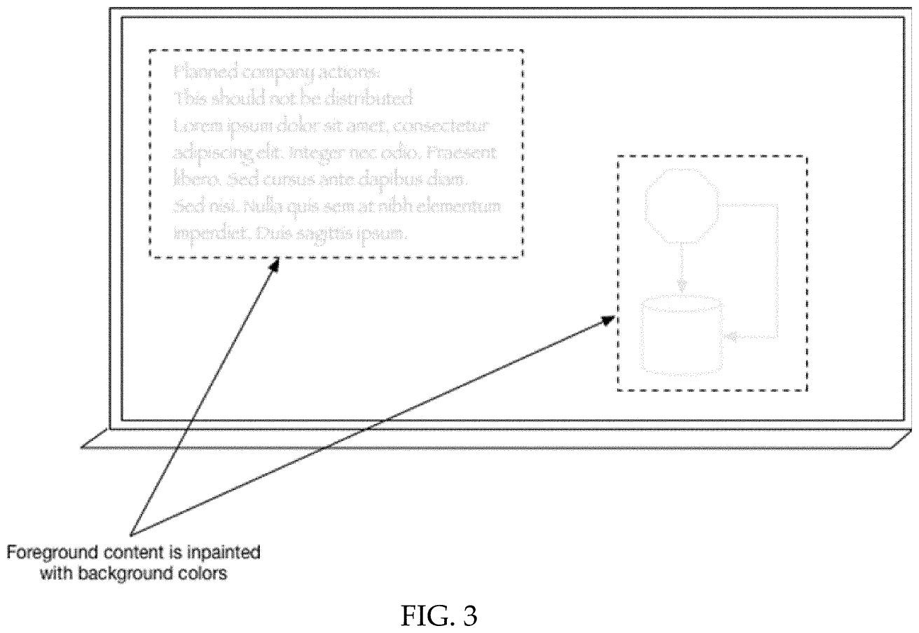

FIG. 3 shows the exemplary image of a whiteboard with the sensitive content of FIG. 1, after the partitioning the image into pixel clusters, the image color partitioning and foreground inpainting applied.

Pixels representing the likely sensitive content to be obfuscated are inpainted with neighboring pixels in the background. There are many inpainting techniques commonly used in image processing such as the fast marching method and those based on fluid dynamical principles. Any such approach can be utilized in this step. An example of the result of Step 1 is shown in FIG. 3.

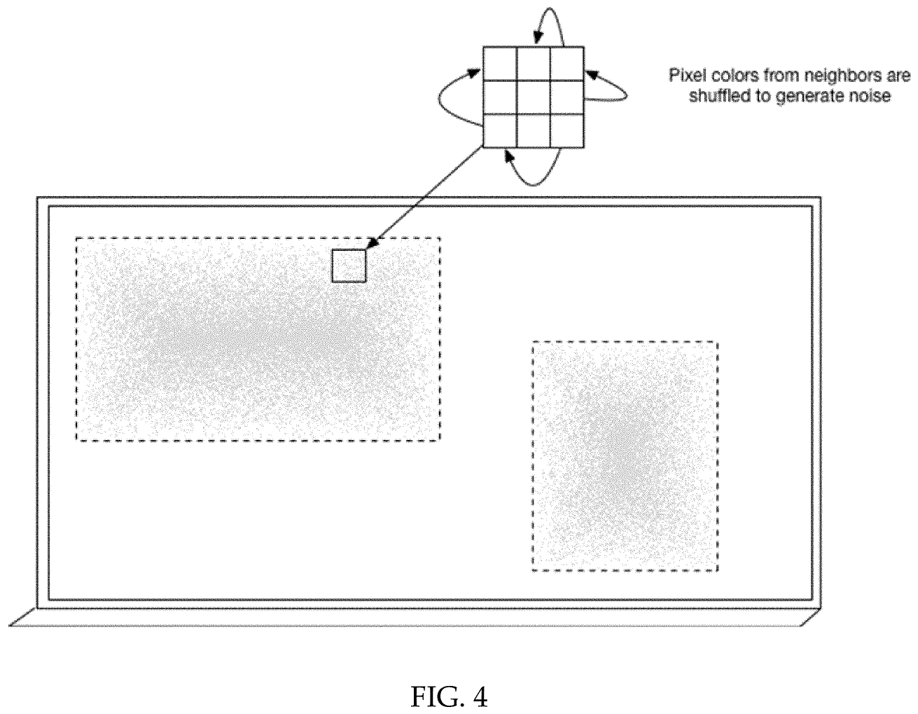

FIG. 4 shows an exemplary result of FIG. 1, after the foreground in painting and introduction of stochastic noise sourced from neighboring pixel colors is applied.

In Step 2, the resulting inpainted image region is irreversibly obfuscated by introducing randomized noise into the region. The source of this random noise comes from neighboring pixels, and the size of each neighborhood is configurable. Each pixel within a neighborhood of pixels is shuffled; swapping color values with other pixels in the defined neighborhood. The method is applied one time or multiple times per pixel with each neighborhood of shuffled pixels changing with each iteration. The shuffling method and system is applied repeatedly to differing neighborhoods of pixel color values. A sample result of Step 2 is illustrated in FIG. 4.

By applying noise generated by randomly shuffling neighborhoods of pixels, the overall region's average color distribution remains unchanged. This means that the region still resembles its original state except that there are no discernable patterns that might be used to infer sensitive information. Moreover as a result of this method, the pixels are distributed randomly within the region. A relatively small region comprised of 16 (4×4) pixels contains 2.092278988 E+13 possible permutations.

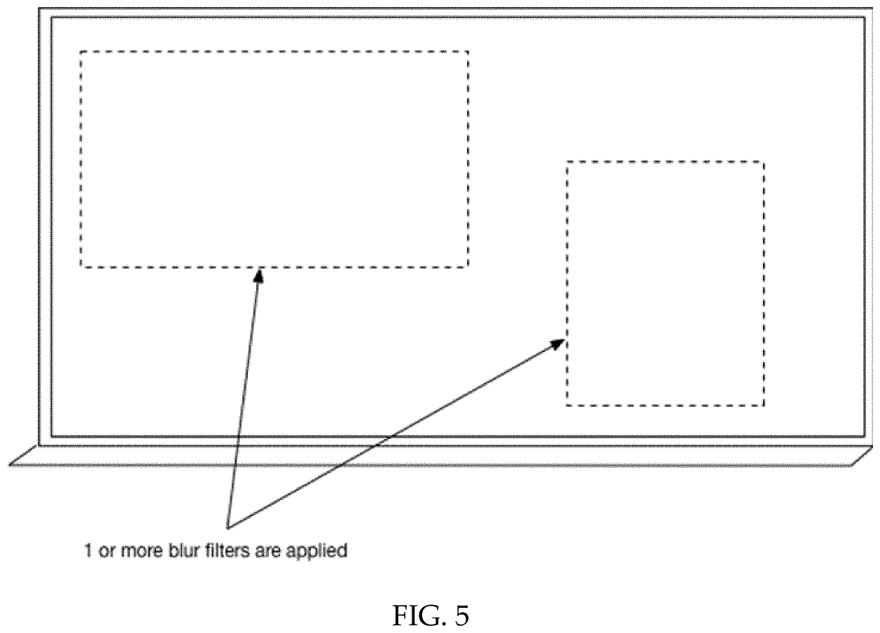

FIG. 5 shows an exemplary result of FIG. 1 after partitioning the image into pixel clusters, encrypting the pixel clusters, and using a blur technique to blend pixilation.

In Step 3, zero, one or more common blur filters may be applied to soften the visual results of Step 2. In some exemplary embodiments, as these filters are applied to already secured content, their function is aesthetic. A sample of commonly used blur filters include Gaussian, Bilateral, Radial, and Box filters. The system may use any number or none of these filters and each may be applied to the image more than once. The final resulting image representation is shown in FIG. 5.

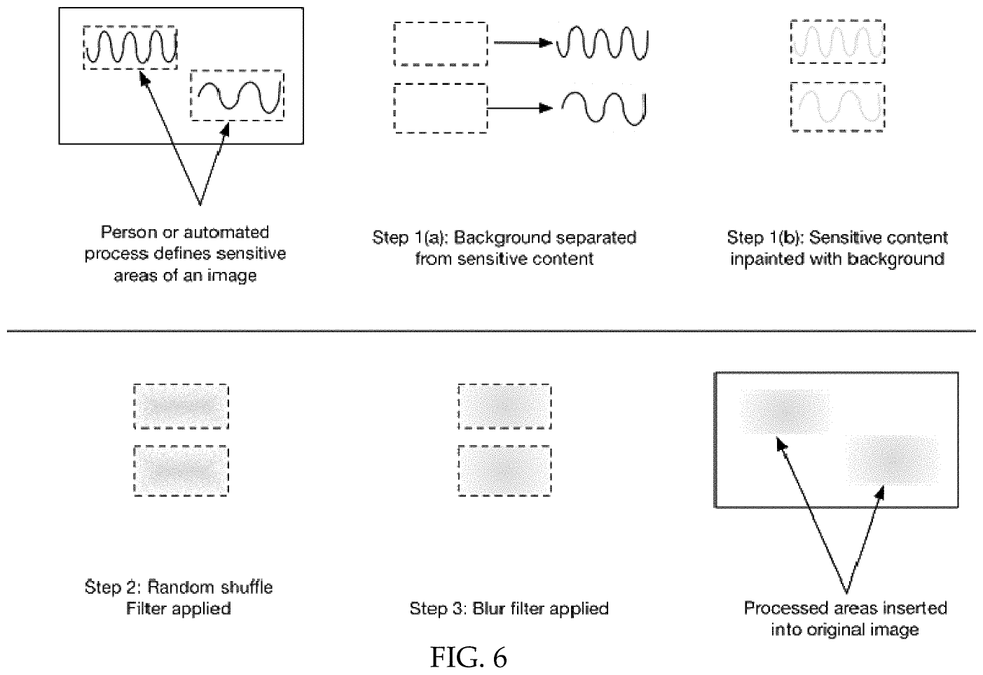

FIG. 6 is an exemplary diagram showing an exemplary sequence of the steps described herein.

Exemplary embodiments include methods and systems defined by the three steps depicted schematically in FIG. 6. They may be used as part of a software package with a video display unit. The area of the image may be drawn as a marquee circumscribing the area or may be selected automatically by a machine learning algorithm performing object detection.

The selected area of the image may apply to any sensitive content, proprietary information or trade secrets captured in an image. This content includes the faces of individual persons, whiteboards, computer monitors, notes, signage, posted information, diagrams, and photographs within the image area.

The method of obfuscation may be applied in the context of digitally documenting the interiors of buildings and similar sensitive sites, securing the privacy of unconsenting persons in the image and readying images for distribution to a broader or public audience.

In the prior art, most blurs are reversible; one can reverse-engineer a blur and recreate its original format. The blurs described herein are superior in two ways. The first way is that from an aesthetic perspective it takes advantage of inpainting, which uses a clustering algorithm to figure out what colors represent the background and what colors represent the foreground. It then separates those two and inpaints the foreground with the background colors. It creates something that captures the shadowing. For example, with a whiteboard, the shadows on the whiteboard that existed beforehand are still there. All of the text is faded to the background color.

The second way the blurs herein are superior is that the systems and methods apply a stochastic blur to the pixels. In photography it's described as a “kernel,” but it's basically a box or shape that is swept back and forth across the image. And within that box those pixels are shuffled. That shuffling means that it's truly random. It would be an impossible undertaking to try to reverse-engineer.

The exemplary systems and methods shown herein can kick off hundreds of nodes at once that securely blur image regions in parallel, and scale those nodes up, and then scale them back down. It leverages an elastic cloud infrastructure. It takes advantage of elastic scaling. This is a computationally intensive operation. Rather than try to have one big machine apply it to a hundred different places, it can kick off a hundred jobs to a hundred machines that get provisioned and scaled in near real-time. It is horizontally scaled. If one tried to perform this on a single machine, one could be sitting for hours; whereas it takes a couple of minutes to get the results back with the systems and methods described herein.

For example, imagine 200 photos shot through a physical space. There might be whiteboards everywhere, people in the scene, things on computer monitors, and sensitive content. This job gets split into sub-jobs for every one of those blur events. A workflow editor application generates a virtual walkthrough of a space with 360-degree photos that are linked together, and then a navigable map of those links so that one can jump around. On a browser, one will draw a marquee that can be any polygonal shape around the thing that they want to “redact” or blur. And once they're done with that, or while they're in the process of that, they can hit “apply,” and all of those marquees that have been selected get processed. Then the processed tour comes back. So one can see the photo tour once again, but this time with all the sensitive content blurred out.

According to further exemplary embodiments, a robot connected to a 360-degree camera may take photos or video. Machine learning may be used to detect and marquee all of the images, or all of the sensitive areas. Similar to how a self-driving car will detect a car in front of it and be able to determine its shape, one can do the same thing with other objects in a scene. Thus, a machine learning, convolutional neural network may generate marquees without any human intervention.

In various exemplary embodiments, a marquee is a boundary around an area viewed as sensitive. The boundary may be expressed in a number of points with a continuous line running through those points. It may be a polygon or it can be many different shapes. But it is ultimately a number of points that are interconnected into a single line that closes a space. For example, machine learning may classify a whiteboard with sensitive information on it. It will ascribe it as a polygon with a marquee around that area because it determines an object to be a whiteboard and can ascribe its outline.

In yet further exemplary embodiments, convolutional neural networks are trained with supervised data, creating a training set that can be thousands or millions of labeled images. And within those labeled images will be whiteboards. And it will put boundaries around those. And based on training that network, knowing what data has those whiteboards and what doesn't, the network learns how to recognize whiteboards. This will work with glass, computer screens, monitors, etc. If it evolves to detect handwriting—not what it says specifically—but that it is likely to be handwriting, the algorithm has additional information to classify these objects.

As already mentioned, one technical advantage is the way information is parallel processed in the cloud, and assembled. A marquee or boundary is effectively a two-dimensional image. And that image is “cubified,” which gives one the optical illusion that they are looking at a flat face of a scene. Those coordinates get translated back into fishbowl-like spherical coordinates so that the marquee is applied to the original 360 image. When the redaction or redactions are applied, they get applied to the 360-degree photo. And then the 360-degree photo of the original that now has the sensitive content blurred out gets retransformed into one of those scenes inside of the tour. Each photo may map to a unique identifier, and the redaction is successfully applied to the correct photo. That scene within the tour which is generated from that photo is regenerated and positioned in the right place in the scene in the tour.

In further exemplary embodiments, a camera's pose from one shot to another shot that's nearby it is determined. For example, the shape of a fire extinguisher is identified from multiple angles. Using epipolar geometry, one can infer where a photo was taken relative to another photo. As one is building an entire tour, and taking a lot of photos, one may determine where each photo lies in a particular space. And so they get automatically mapped into the overall scene.

In even further exemplary embodiments, a virtual digital experience is generated that one can walk through within a browser. The general concept is to give people insight into what the dimensions of a particular space are and what it looks like for planning purposes. The experience is one is looking at the inside of a building from a specific vantage point, and can look all around the 360 degrees and then click on another area that one can see, and it'll move to that area.

The blurring techniques herein can be applied to anything one wants to obfuscate, whether it be within a video or a set of images.

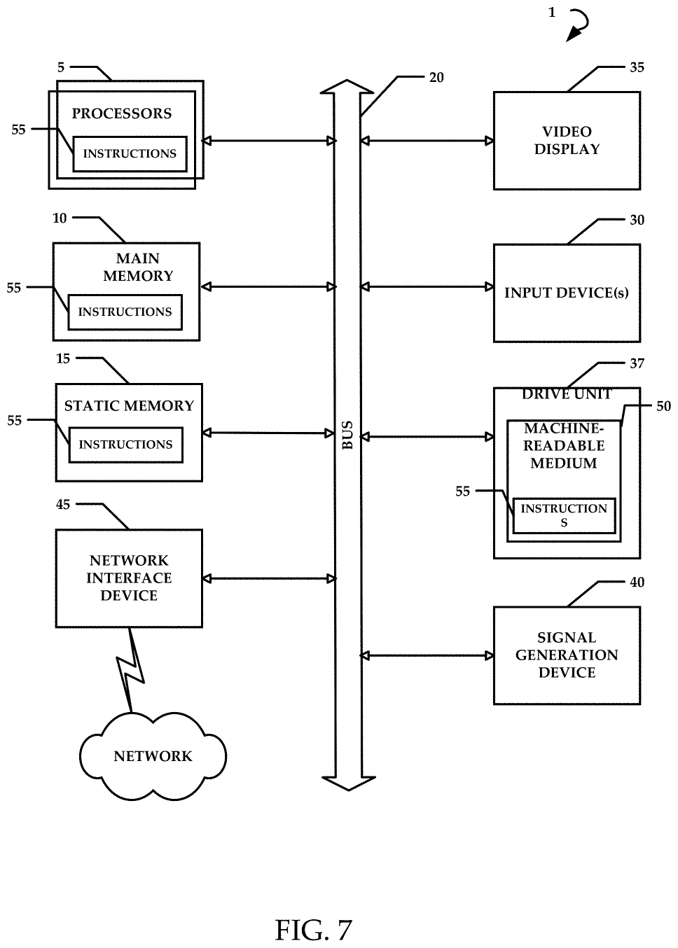

FIG. 7 is a diagrammatic representation of an exemplary system in the form of a computer system 1, within which a set of instructions for causing the machine to perform any one or more of the methodologies discussed herein may be executed. In various example embodiments, the machine operates as a standalone device or may be connected (e.g., networked) to other machines. It could be executed within a Customer Relations Management (“CRM”) system. In some cases, the systems and methods herein may send an API call to Salesforce or the like. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a smart speaker like Echo or Google Home, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network (e.g., network 120) via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

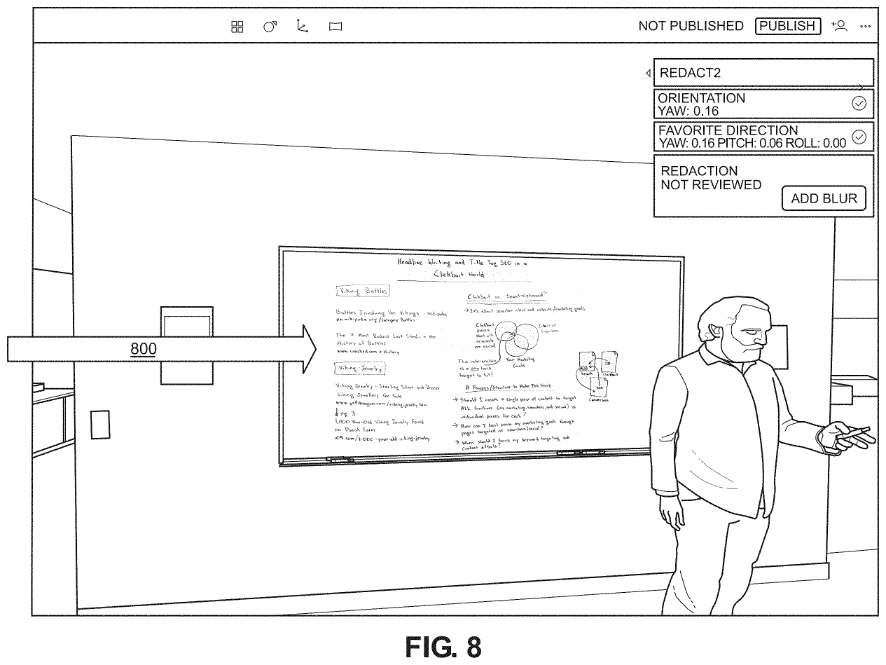

FIG. 8 shows an exemplary real-life scenario of a whiteboard with information 800 on it prior to performing the systems and methods described and illustrated herein.

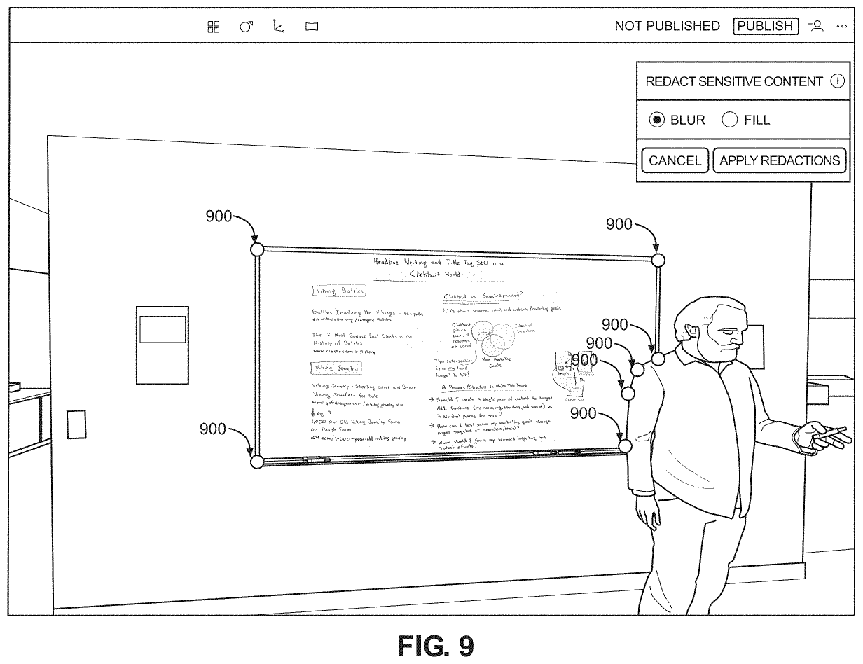

FIG. 9 shows an exemplary real-life scenario of the whiteboard of FIG. 8 with a marquee boundary (comprising a plurality of points 900) around the information to be obfuscated on the whiteboard.

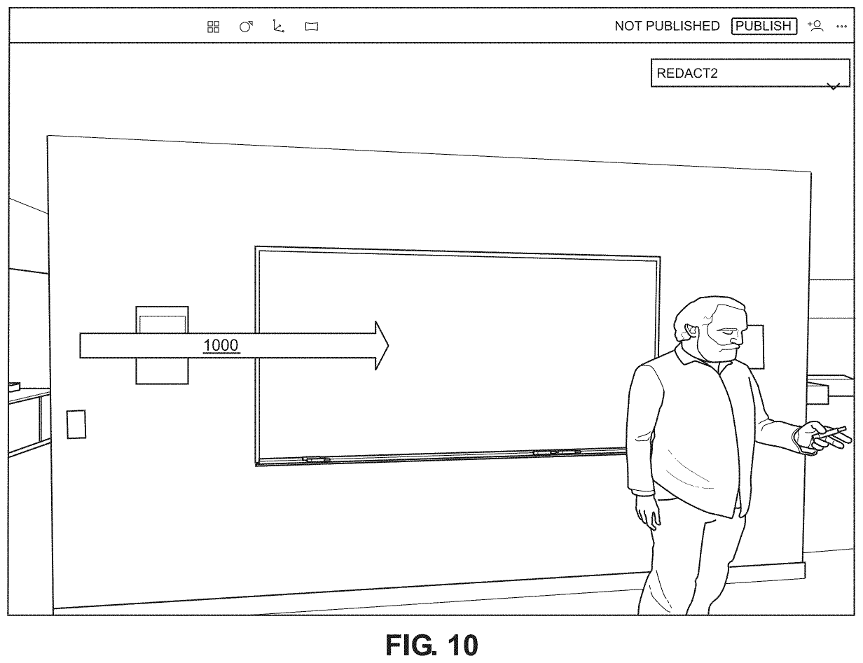

FIG. 10 shows an exemplary real-life scenario of the whiteboard of FIGS. 8-9 with the information on the whiteboard obfuscated as reflected by arrow 1000.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A method for image obfuscation with a computing device, the method comprising:
partitioning an image into pixel clusters;
encrypting the pixel clusters; and
using a blur technique to blend pixelation.

2. The method of claim 1, further comprising the partitioning being based upon colors in the image.

3. The method according to claim 2, further comprising using a vector quantization function that groups pixels based on red, green, or blue color values according to a nearest mean.

4. The method according to claim 3, further comprising generating output in a form of Voroni cells.

5. The method according to claim 4, further comprising each Voroni cell representing a cluster of pixels with similar colors.

6. The method according to claim 5, further comprising a largest cluster representing background pixels of the image being analyzed.

7. The method according to claim 6, the background pixels further comprising a whiteboard or computer screen.

8. The method according to claim 7, further comprising foreground pixels with handwriting, diagrams, displayed text or imagery.

9. The method according to claim 8, further comprising inpainting or interpolating the foreground pixels with the background pixels.

10. The method according to claim 9, further comprising using the background pixels to interpolate pixel color values for each pixel in the foreground, resulting in the foreground pixels fading into the background pixels.

11. The method of claim 1, further comprising encrypting the pixel clusters by shuffling each pixel cluster with a set of neighboring pixel clusters.

12. The method of claim 11, further comprising shuffling multiple times with a different set of neighboring pixel clusters.

13. The method of claim 12, further comprising permanently and randomly changing a numerical color value of each pixel based on available neighboring pixel clusters.

14. The method of claim 13, further comprising adding random noise that appears aesthetically consistent with a scene to a human eye, but cannot computationally be reversed.

15. The method of claim 14, further comprising generating a grainy version of an output of the step of partitioning an image into pixel clusters.

16. The method of claim 1, further comprising using a traditional blur technique such as Gaussian or bilateral to blend the pixilation caused by injected noise.

17. A system for image obfuscation, the system comprising:
a processor; and
a memory for storing executable instructions, the processor executing the instructions to:
partition an image into pixel clusters;
encrypt the pixel clusters; and
use a blur technique to blend pixelation.

18. The system according to claim 17, further comprising the partitioning being based upon colors in the image.

19. The system according to claim 18, further comprising using a vector quantization function that groups pixels based on red, green, or blue color values according to a nearest mean.

20. The system according to claim 19, further comprising generating output in a form of Voroni cells.
